(19) United States
(12) Patent Application Publication
(10) Pub. No.: US 2020/0274910 A1
(43) Pub. Date: Aug. 27, 2020

(54) NETWORK STATUS OF STREAM PUSH TERMINAL-BASED OPTIMIZAITON METHOD, SYSTEM AND STREAM PUSH TERMINAL

(71) Applicant: WANGSU SCIENCE & TECHNOLOGY CO., LTD., Shanghai (CN)

(72) Inventors: Weikun DU, Shanghai (CN); Guohuangshou CHEN, Shanghai (CN)

(21) Appl. No.: 16/063,392

(22) PCT Filed: May 16, 2017
(86) PCT No.: PCT/CN2017/084456

§ 371 Date: Jun. 18, 2018

(30) Foreign Application Priority Data
Apr. 5, 2017 (CN) 201710216528.6

(51) Int. Cl. H04L 29/06; H04L 12/24; H04L 12/26; H04W 24/02

(52) U.S. Cl. CPC H04L 65/80; H04L 65/602; H04L 65/607; H04W 24/02; H04L 41/0896; H04L 43/0876; H04L 65/608

(57) ABSTRACT

A network status of stream push terminal-based optimization method includes: determining, by the stream push terminal, time for transmission of current data based on a present real-time upstream bandwidth; evaluating, by the stream push terminal, whether the time for transmission of the current data exceeds a predefined value; and if the time for transmission of the current data exceeds the predefined value, employing a frame dropping approach to reduce an amount of uploading data.

### FIELD OF THE DISCLOSURE

The present disclosure generally relates to the field of network technology and, more particularly, relates to a network status of stream push terminal-based optimization method, a system, and a stream push terminal thereof.

### BACKGROUND

In recent years, with the rapid development of Internet technology, various streaming media applications have gradually entered the daily life of the majority of Internet users. Many live streaming-like real-time businesses have attracted a large number of users because of their original and innovative content. Therefore, how to optimize audio and video delay and improve user experience has become the development direction of audio and video live streaming services.

At present, with the development of the country's bandwidth acceleration and the rapid development of mobile communication technologies, people are no longer subject to geographical constraints. They can access texts, pictures, and videos through the Internet anytime and anywhere, which greatly enriches people's life in spare time. With the popularization of smartphones and the rapid development of mobile bandwidth, pushing streams using mobile phones has become an important method for video streaming, and more and more people have begun to use mobile phones to broadcast live videos.

However, existing mobile networks have the disadvantages of instability, variability, and being easily affected by the environments and locations, resulting in instability of stream push on the mobile terminals. In addition, the uploading bandwidth on the mobile stream push terminals is uncontrollable and thus is easily affected by objective factors. In the event of bandwidth fluctuations, the viewing terminal is prone to lagging, blurred screen, and increased delay, etc., which will affect the smoothness in watching videos and thus influence the customer experience

### BRIEF SUMMARY OF THE DISCLOSURE

To solve the problems in the existing technology, embodiments of the present disclosure provide a network status of stream push terminal-based optimization method, a system, and a stream push terminal thereof. The technical solutions are as follows:

In one aspect, a network status of stream push terminal-based optimization method includes the following steps:

determining, by the stream push terminal, time for transmission of current data based on a present real-time upstream bandwidth;

evaluating, by the stream push terminal, whether the time for transmission of the current data exceeds a predefined value; and

if the time for transmission of the current data exceeds the predefined value, employing a frame dropping approach to reduce an amount of uploading data.

Further, the step of determining, by the stream push terminal, the time for transmission of the current data based on the present real-time upstream bandwidth specifically includes:

collecting, by the stream push terminal, audio data and/or video data;

audio-encoding and/or video-encoding, by the stream push terminal, the collected audio data and/or video data, respectively;

encapsulating, by the stream push terminal, the encoded audio data and/or the encoded video data into streaming media format data;

placing, by the stream push terminal, the encapsulated streaming media format data into a to-be-transmitted queue;

retrieving, by the stream push terminal, the streaming media format data from the to-be-transmitted queue, and transmitting, by the stream push terminal, the streaming media format data to a relay terminal;

calculating, by the stream push terminal, the present real-time upstream bandwidth by determining in real-time an amount of streaming media format data transmitted in a unit of time; and

determining, by the stream push terminal, the time for transmission of the current data based on the present real-time upstream bandwidth.

Further, the method also includes the following step:

if the time for transmission of the current data does not exceed the predefined value, continuing transmitting, by the stream push terminal, remaining streaming media format data sequentially from the to-be-transmitted queue.

In another aspect, a network status of stream push terminal-based optimization system includes a stream push terminal, a viewing terminal, and a relay terminal, and the stream push terminal pushes collected streaming media format data through the relay terminal to the viewing terminal for viewing, where the stream push terminal specifically includes:

a determination module that is configured to determine time for transmission of current data based on a present real-time upstream bandwidth;

an evaluation module that is configured to evaluate whether the time for transmission of the current data exceeds a predefined value; and

a frame dropping module that is configured to employ a frame dropping approach to reduce an amount of uploading data if the time for transmission of the current data exceeds the predefined value.

Further, the determination module specifically includes:

a collection submodule that is configured to collect audio data and/or video data;

an encoding submodule that is configured to audio-encode and/or video-encode the collected audio data and/or video data, respectively;

a streaming protocol submodule that is configured to encapsulate the encoded audio data and/or the encoded video data into streaming media format data; and

a bandwidth inspection submodule that is configured to place the encapsulated streaming media format data into a to-be-transmitted queue, retrieve the streaming media format data from the to-be-transmitted queue and transmit the streaming media format data to the relay terminal, calculate the present real-time upstream bandwidth by determining in real-time an amount of streaming media format data transmitted in a unit of time, and determine the time for transmission of the current data based on the present real-time upstream bandwidth.

Further, the stream push terminal also specifically includes:

a transmission module that is configured to continue transmitting remaining streaming media format data sequentially from the to-be-transmitted queue if the time for transmission of the current data does not exceed the predefined value.

In another aspect, a stream push terminal includes:

a determination module that is configured to determine time for transmission of current data based on a present real-time upstream bandwidth;

an evaluation module that is configured to evaluate whether the time for transmission of the current data exceeds a predefined value; and

a frame dropping module that is configured to employ a frame dropping approach to reduce an amount of uploading data if the time for transmission of the current data exceeds the predefined value.

Further, the determination module specifically includes:

a collection submodule that is configured to collect audio data and/or video data;

an encoding submodule that is configured to audio-encode and/or video-encode the collected audio data and/or video data, respectively;

a streaming protocol submodule that is configured to encapsulate the encoded audio data and/or the encoded video data into streaming media format data; and

a bandwidth inspection submodule that is configured to place the encapsulated streaming media format data into a to-be-transmitted queue, retrieve the streaming media format data from the to-be-transmitted queue and transmit the streaming media format data to a relay terminal, and calculate the present real-time upstream bandwidth by determining in real-time an amount of streaming media format data transmitted in a unit of time.

Further, the bandwidth inspection submodule is also configured to determine the time for transmission of the current data based on the present real-time upstream bandwidth.

Further, the stream push terminal also specifically includes:

a transmission module that is configured to continue transmitting remaining streaming media format data sequentially from the to-be-transmitted queue if the time for transmission of the current data does not exceed the predefined value.

The technical solutions provided by the embodiments of the present disclosure give rise to the following beneficial effects: they allow real-time inspection of the network status of the stream push terminal, real-time monitoring of the variations of the upstream bandwidth, control of production from the source, reduction of the production volume, and reduction of the amount of uploading data. This allows clients to smoothly push streams under the situation that the upstream bandwidth of the stream push terminal is not optimal, which greatly improves the viewing experience of users. When the bandwidth is detected to gradually get better, frame dropping is stopped, so that the quality of the pushed streams in the stream push terminal is ensured.

### BRIEF DESCRIPTION OF THE DRAWINGS

To make the technical solutions in the embodiments of the present disclosure clearer, a brief introduction of the accompanying drawings consistent with descriptions of the embodiments will be provided hereinafter. It is to be understood that the following described drawings are merely some embodiments of the present disclosure. Based on the accompanying drawings and without creative efforts, persons of ordinary skill in the art may derive other drawings.

FIG. 1 is a flowchart of a network status of stream push terminal-based optimization method according to one embodiment of the present disclosure;

FIG. 2 is a flowchart of detailed sub-steps of Step 51 shown FIG. 1 according to one embodiment of the present disclosure;

FIG. 3 is a schematic diagram of an internal structure of a network status of stream push terminal-based optimization system 10 according to one embodiment of the present disclosure; and

FIG. 4 is a schematic diagram of an internal structure of a determination module 111 of a stream push terminal 11 shown in FIG. 3 according to one embodiment of the present disclosure.

### DETAILED DESCRIPTION

To make the objectives, technical solutions, and advantages of the present disclosure clearer, specific embodiments of the present disclosure will be made in detail with reference to the accompanying drawings. It should be understood that the specific embodiments described herein are merely used to explain the present disclosure and shall not be construed as limiting the present disclosure.

A network status of stream push terminal-based optimization method consistent with the present disclosure will be described in detail hereinafter.

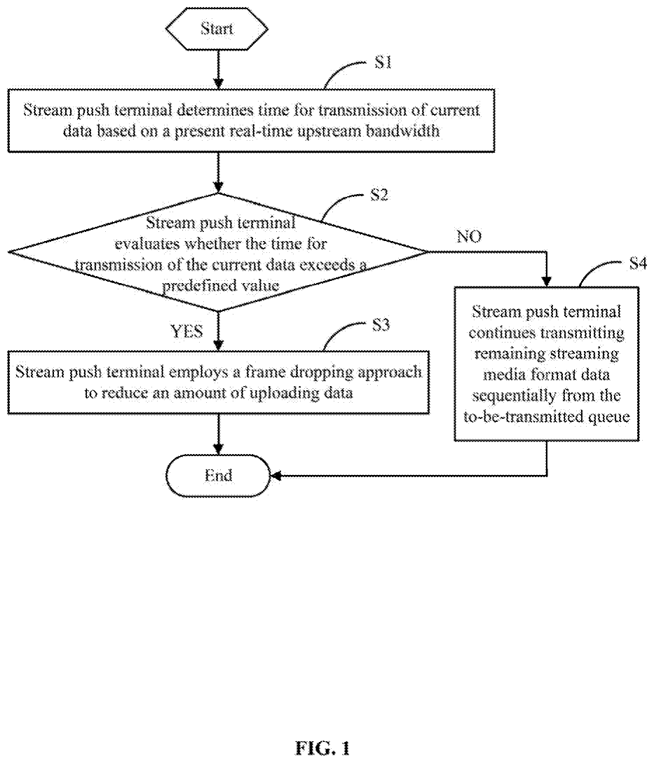

Referring to FIG. 1, a flowchart of a network status of stream push terminal-based optimization method according to one embodiment of the present disclosure is provided.

In one embodiment, the network status of stream push terminal-based optimization method is applied to a network status of stream push terminal-based optimization system, where the network status of stream push terminal-based optimization system includes a stream push terminal, a viewing terminal, and a relay terminal. The stream push terminal pushes the collected streaming media format data, through the relay terminal, to the viewing terminal for viewing. The stream push terminal refers to a terminal device of a user, such as a mobile phone, a tablet, or a personal digital assistant, etc. The relay terminal may include various transit devices in the network, such as routers and servers, and may specifically be a CDN (content delivery network) streaming media cluster. The viewing terminal may include various receiving and display terminals for streaming media data, such as mobile display terminals (e.g., a mobile phone, a tablet, etc.) and non-mobile display terminals (e.g., a desktop computer, etc.). The stream push terminal includes at least a voice collection device (e.g., a microphone, etc.) and a video capture device (e.g., a camera, etc.), through which the streaming media format data is collected. The collected streaming media format data is pushed, through forwarding by the relay terminal, to the viewing terminal for viewing.

The method of the present disclosure mainly optimizes the stream push terminal, that is, optimize from the source. The function of the stream push terminal may be divided into three processes: collection, encoding, and transmission, each of which affects each other. The collection comes first, the coding later, and then the transmission. This is a production and consumption procedure. From the transmission process, the present disclosure determines whether the previous processes have dropped frames based on the situation of eventual consumption, and controls the production based on the eventual situation, that is, to control the collection frequency directly from the collection process.

At Step S1, the stream push terminal determines the time for transmission of the current data based on the present real-time upstream bandwidth.

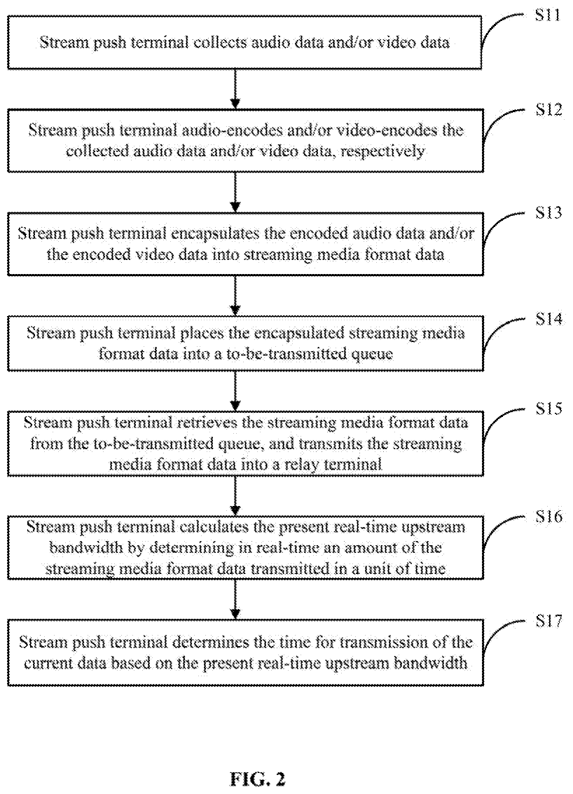

In one embodiment, the Step S1 of determining, by the stream push terminal, the time for transmission of the current data based on the present real-time upstream bandwidth specifically includes seven sub-steps S11-S17, as shown in FIG. 2.

Referring to FIG. 2, a flowchart of detailed sub-steps of Step Si shown in FIG. 1 according to one embodiment of the present disclosure is illustrated.

At Step S11, the stream push terminal collects audio data and/or video data.

In one embodiment, the stream push terminal collects voice data, such as pulse code modulation (PCM) format voice data, through its voice collection device (e.g., a microphone, etc.). At the same time, the stream push terminal collects video data in a format like YUV or voice data in a format like PCM in a callback manner through its video capture device (e.g., a camera, etc.) or an interface of the system.

In one embodiment, specific collection process may be, for example, as follows:

(1) For video: collect video data through its video capture device (e.g., camera, etc.), and set up the frame rate, the width and height, etc. For examples, the frame rate is 25 frames/sec, the height and weight are 720*1080, and the system callbacks YUV data every 1000 ms/25=40 ms.

(2) For audio: collect voice data through its voice collection device (e.g., a microphone, etc.), and set up the sampling rate, the number of channels, the number of bits, etc. For example, the sampling rate is 44,100, the number of channels is 2, and the number of bits is 16. That is, 44,100 samples are collected per second, and each sample has 2 channels, each with 16 bits.

At Step S12, the collected audio data and/or video data are respectively audio-encoded and/or video-encoded. For example, the YUV and PCM data are respectively encoded into H.264 and AAC data using encoding tools such as FFMPEG, X264, FAAC, and hardcoding.

In one embodiment, an H.264 video encoding method is used to encode the collected video data into H.264 format video data, and an advanced audio coding (AAC) method is used to encode the collected audio data into AAC format audio data.

In one embodiment, specific encoding process may be, for example, as follows:

(1) Video encoding: initialize video encoding parameters, including the width and height, the frame rate, the bit rate, and the bit rate mode, etc., call the encoding interface of an encoder, encode the YUV data called back by the system into H.264 data, and encapsulate the H.264 data into streaming media format through a streaming protocol submodule. For example, the width and height are 720*1080, the frame rate is 25, the code rate is 1 Mbps, etc., and the YUV data is encoded into H.264 data using X264, FFMPEG, or hardcoding.

(2) Audio coding: initialize audio encoding parameters, including the sampling rate, the number of channels, and the number of bits, etc., and encode the PCM data called back by the system into AAC data through the encoding interface of an AAC encoder. For example, the sampling rate is 44,100, the number of channels is 2, the number of bits is 16, and the PCM data is encoded into AAC data using encoders such as FAAC and hardcoding.

(3) Sequentially place the audio/video data into the streaming protocol submodule based on the sequence of collection, and convert the audio/video data into streaming media format data.

At Step S13, the encoded audio data and/or the encoded video data are encapsulated into streaming media format data. Based on different streaming protocols, such as the RTMP (real-time messaging protocol) streaming protocol, the H.264 and AAC data are encoded into data conforming to the RTMP protocol.

In one embodiment, the RTMP protocol is employed to encapsulate the encoded audio data and/or the encoded video data into RTMP format streaming media data.

In one embodiment, specific encapsulation process may be, for example, as follows:

(1) Establish a connection with a server using the RTMP protocol, and acquire an address for broadcasting streams.

(2) Retrieve the H.264 data, the AAC data, etc. that are generated by the encoders, generate a sequence based on the time of collection by the encoders, and based on the time in the sequence, encapsulate the H.264 data, the AAC data, etc., respectively, according to the RTMP protocol.

(3) Place the encapsulated streaming media format data into a to-be-transmitted queue. When placing the encapsulated streaming media format data into the queue, the encoding information, such as the width and height of the video, the bit rate, the frame rate, the audio sampling rate, and the number of channels, is placed into the queue as well. The data placed into the queue may wait for data transmission by the transmission module.

At Step S14, the encapsulated streaming media format data is placed into the to-be-transmitted queue.

In one embodiment, a temporary storage area is assigned in the memory of the stream push terminal for temporarily storing the streaming media data. The streaming media data encapsulated according to the RTMP protocol is placed into the to-be-transmitted queue, and the to-be-transmitted queue is stored in the temporary storage area of the memory.

At Step S15, the streaming media format data is retrieved from the to-be-transmitted queue and is transmitted to the relay terminal.

At Step S16, the present real-time upstream bandwidth is calculated by determining in real-time an amount of streaming media format data transmitted in a unit of time.

In one embodiment, specific calculation process may be, for example, as follows:

(1) After retrieving the data from the queue, transmit a frame and record the time used for the transmission and the size of the transmitted data.

(2) Because a delay is determined based on the real-time transmission rate and the buffered data in the to-be-transmitted queue, configuring a unit of time for counting/calculation becomes necessary, which is called the unit of time. Based on the configured unit of time, determine the total data transmitted in a currently configured unit of time, and the total data/ the total duration=the transmitting rate.

(3) Calculate the amount of buffered remaining data in the to-be-transmitted queue, and determine the time for transmission of the current to-be-transmitted streaming media data based on the calculated upstream bandwidth and the data amount of the buffered remaining streaming media data in the to-be-transmitted queue.

In one embodiment, the unit of time can be flexibly configured based on the requirements. For example, the unit of time is 1 s. Partial data may be retrieved from the streaming media data in the to-be-transmitted queue and be placed into the transmission module for transmission, and the amount of the part of the streaming media data that is transmitted in a unit of time may be determined in real-time. For example, 8 MB of streaming media data is transmitted within a unit of time of 1 s, and the calculated transmission rate for upstreaming data is 8 Mbps, then the present upstream bandwidth is 1 M.

At Step S17, the time for transmission of the current data is determined based on the present real-time upstream bandwidth.

In one embodiment, after partial data has been transmitted to determine the upstream bandwidth, the amount of buffered remaining data in the to-be-transmitted queue is calculated. Based on the calculated upstream bandwidth and the data amount of the buffered remaining streaming media data in the to-be-transmitted queue, the time for transmission of the current to-be-transmitted streaming media data is then calculated. For example, the unit of time is 1 s, the streaming media data in the to-be-transmitted queue has a total size of 12 MB, and the transmission rate of the upstreaming data calculated from the previously retrieved part of the data (e.g., 8 MB) in a unit of time is 8 Mbps, that is, the upstream bandwidth is 1 M. Then, the calculated amount of the remaining streaming media data is 4 MB. Therefore, based on the present real-time upstream bandwidth and the amount of the remaining streaming media data, the calculated time for transmission of the current to-be-transmitted streaming media data is 500 ms.

That is, it is predicted to take 500 ms to finish transmission of the remaining streaming media data.

Referring back to FIG. 1, at Step S2, the stream push terminal evaluates whether the time for transmission of the current data exceeds a predefined value.

In one embodiment, the predefined value can be flexibly defined based on the requirements. For example, the predefined value is 400 ms.

If the time for transmission of the current data exceeds the predefined value, then the frame dropping approach is employed to reduce the amount of uploading data at Step S3.

In one embodiment, specific frame dropping process may be, for example, as follows:

(1) Based on the total amount of data currently buffered and the current real-time transmission rate, calculate: the total amount of data/the real-time transmission rate=the time for transmission. The predefined time for transmission is denoted as T1, and the present time for transmission is denoted as Tn.

(2) When encoding, initialize a frame rate of k, predefine a frame dropping lower limit of k1, and upper limit of k2 as current predefined frame rates, and denote the current actual frame rate as kn. Initialize kn=k, and the range for the current frame rate lies between k1 and k2, that is, k1≤kn≤k2. In general, by default, k2=k. That is, the upper limit of k2 is initialized. The new frame rate is kn=kn/(Tn/T1), and this frame rate changes in real time.

(3) If the time for transmission of the current data exceeds the predefined value, that is, Tn>T1, the frame dropping approach is employed to reduce the amount of uploading data. Specific frame dropping process includes: if kn>k2, then kn=k2; and if kn<k1, then kn=k1.

(4) If the time for transmission of the current data does not exceed the predefined value, that is, Tn<Ti, then gradually increase the frame rate until it recovers to the current maximum frame rate. The formula for the increasing process is: new kn=kn/(Tn/T1).

In one embodiment, for example, the initialized frame rate is set as 25, the upper limit is 25, and the lower limit is 10. Assume that the calculated time for transmission of the current data is 500 ms as stated in the above example. Since 500 ms is greater than the predefined value of 400 ms, if all data is uploaded, the influence of the bandwidth may lead to a poor viewing experience such as lagging, blurred screen, or increased delay, etc. in the pushed live streams received in the viewing terminal. Therefore, in order to improve the viewing experience, the frame dropping module is activated, and the new frame rate is kn=kn/(Tn/T1). Based on the formula, the new kn=25/(500/400). That is, kn=20 frames/sec, or 20 frames are generated per second. The amount of uploading data may be reduced by employing the frame dropping approach until the time for transmission of the amount of the buffered remaining data is less than the predefined value of 400 ms. If the time for transmission of the current data is calculated as 300 ms in the above example, the current frame rate is 20, and the new frame rate is kn=kn/(Tn/T1), based on the formula, the new kn=20/(300/400). That is, kn=26 frames/sec. Because kn>the upper limit k2, kn=k2=25 frames/sec.

If the time for transmission of the current data does not exceed the predefined value, and the frame rate reaches the upper limit, continues transmitting remaining streaming media format data sequentially from the to-be-transmitted queue at Step S4.

In one embodiment, specific transmission process may be, for example, as follows:

(1) The RTMP protocol-based inter-connection with the server has already been set up using the RTMP streaming protocol. To-be-transmitted streaming media format data is circularly retrieved from the to-be-transmitted queue and is transmitted to the streaming media data.

(2) The server receives the streaming media format data from the client terminal, and distributes it to each client terminal.

In one embodiment, if the calculated time for transmission of the current data is 150 ms, which is less than the predefined value of 400 ms, it means that the current upstream bandwidth is sufficient. In order to ensure the quality of the pushed streams at the stream push terminal, frame dropping is stopped, and the frame rate is increased. Further, sequential transmission of the remaining streaming media format data from the to-be-transmitted queue continues, to ensure the smoothness of the stream push service and improve the viewing experience in the viewing terminal.

The TCP protocol-based network status of stream push terminal-based optimization method provided by the present disclosure allows real-time inspection of the network status of the stream push terminal, real-time monitoring of the variations of the upstream bandwidth, control of production from the source, reduction of production volume, and reduction of the amount of uploading data. This allows clients to smoothly push streams under the situation that the upstream bandwidth of the stream push terminal is not optimal, which greatly improves the viewing experience of users. When the bandwidth is detected to gradually get better, frame dropping is stopped, so that the quality of the pushed streams in the stream push terminal is ensured.

A network status of stream push terminal-based optimization system consistent with the present disclosure will be described in detail hereinafter.

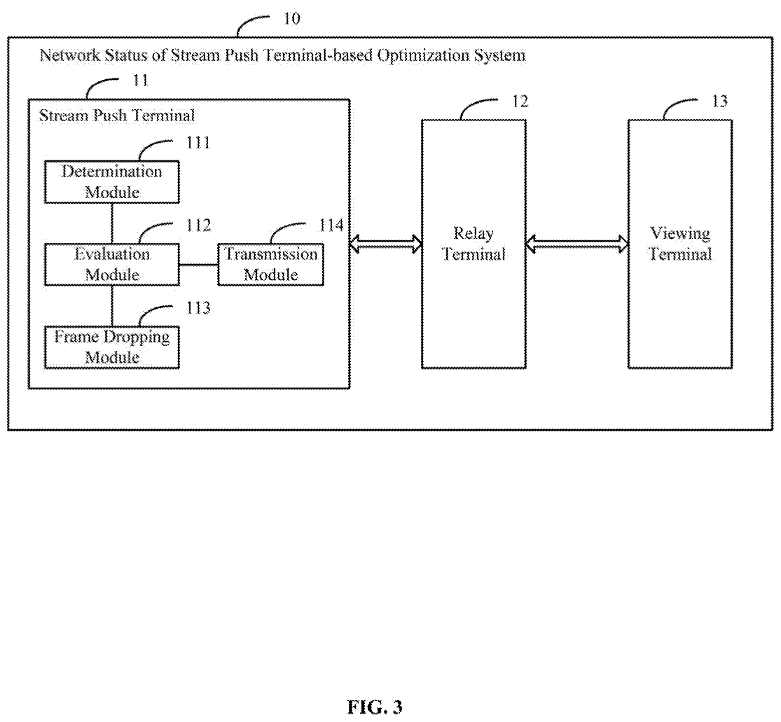

Referring to FIG. 3, a schematic diagram of an internal structure of a TCP-based network status of stream push terminal-based optimization system 10 according to one embodiment of the present disclosure is illustrated.

In one embodiment, the network status of stream push terminal-based optimization system 10 includes a stream push terminal 11, a viewing terminal 13, and a relay terminal 12, where the stream push terminal 11 pushes the collected streaming media format data, through the relay terminal 12, to the viewing terminal 13 for viewing. The stream push terminal 11 refers to a terminal device of a user, including a mobile phone, a tablet, and a personal digital assistant, etc. The relay terminal 12 may include various transit devices in the network, such as routers and servers. The viewing terminal 13 may include various receiving and display terminals for streaming media data, such as mobile display terminals (e.g., a mobile phone, a tablet, etc.) and non-mobile display terminals (e.g., a desktop computer, etc.). The stream push terminal 11 includes at least a voice collection device (e.g., a microphone, etc.) and a video capture device (e.g., a camera, etc.), through which the streaming media format data is collected. The collected streaming media format data is pushed, through forwarding by the relay terminal 12, to the viewing terminal for viewing. Here, the relay terminal 12 may include multiple units. The stream push terminal 11 pushes the collected streaming media format data, through a single relay terminal 12 or multiple relay terminals 12, to the viewing terminal 13 for viewing.

The system of the present disclosure mainly optimizes the stream push terminal 11, that is, optimize from the source. The function of the stream push terminal 11 may be divided into three processes: collection, encoding, and transmission, each of which affects each other. The collection comes first, the coding later, and then the transmission. This is a production and consumption procedure. Through the transmission process, the present disclosure determines whether the previous processes have dropped frames based on the situation of eventual consumption, and controls the production based on the eventual situation, that is, to control the collection frequency directly from the collection process.

The stream push terminal 11 specifically includes: a determination module 111, an evaluation module 112, a frame dropping module 113, and a transmission module 114.

The determination module 111 is configured to determine the time for transmission of the current data based on the present real-time upstream bandwidth.

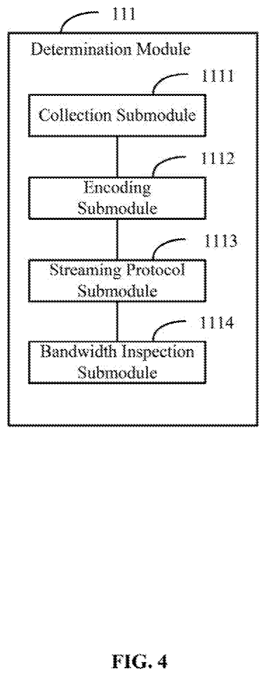

Here, the determination module 111 specifically includes: a collection submodule 1111, an encoding submodule 1112, a streaming protocol submodule 1113, and a bandwidth inspection submodule 1114, as shown in FIG. 4.

Referring to FIG. 4, a schematic diagram of an internal structure of a determination module 111 of a stream push terminal 11 shown in FIG. 3 according to one embodiment of the present disclosure is illustrated.

The collection submodule 1111 is configured to collect audio data and/or video data.

In one embodiment, the collection submodule 1111 collects voice data, such as PCM format voice data, through its voice collection device (e.g., a microphone, etc.). At the same time, the collection submodule 1111 collects video data in a format like YUV or voice data in a format like PCM in a callback manner through its video capture device (e.g., a camera, etc.) or an interface of the system.

In one embodiment, specific collection process may be, for example, as follows:

(1) For video: collect video data through its video capture device (e.g., camera, etc.), and set up the frame rate, the width and height, etc. For examples, the frame rate is 25 frames/sec, the height and weight are 720*1080, and the system callbacks YUV data every 1000 ms/25=40 ms.

(2) For audio: collect voice data through its voice collection device (e.g., a microphone, etc.), and set up the sampling rate, the number of channels, the number of bits, etc. For example, the sampling rate is 44,100, the number of channels is 2, and the number of bits is 16. That is, 44,100 samples are collected per second, and each sample has 2 channels, each with 16 bits.

The encoding submodule 1112 is configured to audio-encode and/or video-encode the collected audio data and/or video data, respectively. For example, the YUV and PCM data are respectively encoded into H.264 and AAC data using encoding tools such as FFMPEG, X264, FAAC, and hardcoding.

In one embodiment, an H.264 video encoding method is used to encode the collected video data into H.264 format video data, and an AAC method is used to encode the collected audio data into AAC format audio data.

In one embodiment, specific encoding process may be, for example, as follows:

(1) Video encoding: initialize video encoding parameters, including the width and height, the frame rate, the bit rate, and the bit rate mode, etc., call the encoding interface of an encoder, encode the YUV data called back by the system into H.264 data, and encapsulate the H.264 data into streaming media format through a streaming protocol submodule. For example, the width and height are 720*1080, the frame rate is 25, the code rate is 1 Mbps, etc., and the YUV data is encoded into H.264 data using X264, FFMPEG, or hardcoding.

(2) Audio coding: initialize audio encoding parameters, including the sampling rate, the number of channels, and the number of bits, etc., and encode the PCM data called back by the system into AAC data through the encoding interface of an AAC encoder. For example, the sampling rate is 44,100, the number of channels is 2, the number of bits is 16, and the PCM data is encoded into AAC data using encoders such as FAAC, and hardcoding.

(3) Sequentially place the audio/video data into the streaming protocol submodule based on the sequence of collection, and convert the audio/video data into streaming media format data.

The streaming protocol submodule 1113 is configured to encapsulate the encoded audio data and/or the encoded video data into streaming media format data. Based on different streaming protocols, such as the RTMP streaming protocol, the H.264 and AAC data are encoded into data conforming to the RTMP protocol.

In one embodiment, the RTMP protocol is employed to encapsulate the encoded audio data and/or the encoded video data into RTMP format streaming media data.

In one embodiment, specific encapsulation process may be, for example, as follows:

(1) Establish a connection with a server using the RTMP protocol, and acquire an address for broadcasting streams.

(2) Retrieve the H.264 data, the AAC data, etc. that are generated by the encoders, generate a sequence based on the time of collection by the encoders, and based on the time in the sequence, encapsulate the H.264 data, the AAC data, etc., respectively, according to the RTMP protocol.

(3) Place the encapsulated streaming media format data into a to-be-transmitted queue. When placing the encapsulated streaming media format data into the queue, the encoding information, such as the width and height of the video, the bit rate, the frame rate, the audio sampling rate, and the number of channels, etc., is placed into the queue as well. The data placed into the queue may wait for data transmission by the transmission module.

The bandwidth inspection submodule 1114 is configured to place the encapsulated streaming media format data into the to-be-transmitted queue, calculate the present real-time upstream bandwidth by determining in real-time an amount of streaming media format data transmitted in a unit of time, and determine the time for transmission of the current data based on the present real-time upstream bandwidth.

In one embodiment, a temporary storage area is assigned in the memory of the stream push terminal 11 for temporarily storing the streaming media data. The streaming media data encapsulated according to the RTMP protocol is placed into the to-be-transmitted queue, and the to-be-transmitted queue is stored in the temporary storage area of the memory.

In one embodiment, specific calculation process may be, for example, as follows:

(1) After retrieving the data from the queue, transmit a frame and record the time for the transmission and the size of the transmitted data.

(2) Because a delay is determined based on the real-time transmission rate and the buffered data in the to-be-transmitted queue, configuring a unit of time for counting/calculation becomes necessary, which is called the unit of time. Based on the configured unit of time, determine the total data transmitted in a currently configured unit of time, and the total data/the total duration=the transmitting rate.

(3) Calculate the amount of buffered remaining data in the to-be-transmitted queue, and determine the time for transmission of the current to-be-transmitted streaming media data based on the calculated upstream bandwidth and the data amount of the buffered remaining streaming media data in the to-be-transmitted queue.

In one embodiment, the unit of time can be flexibly configured based on the requirements. For example, the unit of time is 1 s. Partial data may be retrieved from the streaming media data in the to-be-transmitted queue and is placed into the transmission module for transmission, and the amount of the part of the streaming media data that is transmitted in a unit of time is determined in real-time. For example, 8 MB of streaming media data is transmitted within a unit of time of 1 s, and the calculated transmission rate for upstreaming data is 8 Mbps, then the present upstream bandwidth is 1 M.

In one embodiment, after partial data has been transmitted to determine the upstream bandwidth, the amount of buffered remaining data in the to-be-transmitted queue is calculated. Based on the calculated upstream bandwidth and the data amount of the buffered remaining streaming media data in the to-be-transmitted queue, the time for transmission of the current to-be-transmitted streaming media data is then calculated. For example, the streaming media data in the to-be-transmitted queue has a total size of 12 MB, and the transmission rate of the upstreaming data calculated from the previously retrieved part of the data (e.g., 8 MB) is 8 Mbps, that is, the upstream bandwidth is 1 M. Then, the determined amount of the remaining streaming media data is 4 MB. Therefore, based on the present real-time upstream bandwidth and the amount of the remaining streaming media data, the calculated time for transmission of the current to-be-transmitted streaming media data is 500 ms. That is, it is predicted to take 500 ms to finish transmission of the remaining streaming media data.

Referring back to FIG. 3, the evaluation module 112 is configured to evaluate whether the time for transmission of the current data exceeds a predefined value.

In one embodiment, the predefined value can be flexibly defined based on the requirements. For example, the predefined value is 400 ms.

The frame dropping module 113 is configured to employ a frame dropping approach to reduce the amount of uploading data if the time for transmission of the current data exceeds the predefined value.

In one embodiment, specific frame dropping process may be, for example, as follows:

(1) Based on the total amount of data currently buffered, and the present real-time transmission rate, calculate: the total amount of data/the real-time transmission rate=the time for transmission. The predefined time for transmission is denoted as T1, and the present time for transmission is denoted as Tn.

(2) When encoding, initialize a frame rate of k, predefine a frame dropping lower limit of k1, and upper limit of k2 as the current predefined frame rates, and denote the current actual frame rate as kn. Initialize kn=k, the current frame rate range lies between k1 and k2, that is, k1≤kn≤k2. In general, by default, k2=k. That is, the upper limit of k2 is initialized. The new frame rate is kn=kn/(Tn/T1), and this frame rate changes in real time.

(3) If the time for transmission of the current data exceeds the predefined value, that is, Tn>T1, the frame dropping approach is employed to reduce the amount of uploading data. Specific frame dropping process includes: if kn>k2, then kn=k2; and if kn<k1, then kn=k1.

(4) If the time for transmission of the current data does not exceed the predefined value, that is, Tn<T1, then gradually increase the frame rate until it recovers to the current maximum frame rate. The formula for the increasing process is: new kn=kn/(Tn/T1).

In one embodiment, for example, the initialized frame rate is set as 25, the upper limit is 25, and the lower limit is 10. Assume that the calculated time for transmission of the current data is 500 ms as stated in the above example. Since 500 ms is greater than the predefined value of 400 ms, if all data is uploaded, the influence of the bandwidth may lead to a poor viewing experience such as lagging, blurred screen, or increased delay, etc. in the pushed live streams received in the viewing terminal 13. Therefore, in order to improve the viewing experience, the frame dropping module is activated, and the new frame rate is kn=kn/(Tn/T1). Based on the formula, the new kn=25/(500/400). That is, kn=20 frames/sec, or 20 frames are generated per second. The amount of uploading data may be reduced by employing the frame dropping approach until the time for transmission of the amount of the buffered remaining data is less than the predefined value of 400 ms. If the time for transmission of the current data is calculated as 300 ms in the above example, the current frame rate is 20, and the new frame rate is kn=kn/(Tn/T1), based on the formula, the new kn=20/(300/400). That is, kn=26 frames/sec. Because kn>the upper limit k2, kn=k2=25 frames/sec.

The transmission module 114 is configured to continue transmitting the remaining streaming media format data sequentially from the to-be-transmitted queue if the time for transmission of the current data does not exceed the predefined value and the frame rate reaches the upper limit.

In one embodiment, specific transmission process may be, for example, as follows:

(1) The RTMP protocol-based inter-connection with the server has already been established using the RTMP streaming protocol. To-be-transmitted streaming media format data is circularly retrieved from the to-be-transmitted queue and is transmitted to the streaming media data.

(2) The server receives the streaming media format data from the client terminal, and distributes it to each client terminal.

In one embodiment, if the calculated time for transmission of the current data is 150 ms, which is less than the predefined value of 400 ms, it means that the current upstream bandwidth is sufficient. In order to ensure the quality of the pushed streams in the stream push terminal 11, frame dropping is stopped, and the frame rate is increased. Further, sequential transmission of the remaining streaming media format data from the to-be-transmitted queue continues, to ensure the smoothness of the stream push service and improve the viewing experience in the viewing terminal.

The TCP protocol-based network status of stream push terminal-based optimization system 10 provided by the present disclosure allows real-time inspection of the network status in the stream push terminal, real-time monitoring of the variations of the upstream bandwidth, control of production from the source, reduction of production volume, and reduction of the amount of uploading data. This allows clients to smoothly push streams under the situation that the upstream bandwidth of the stream push terminal is not optimal, which greatly improves the viewing experience of users. When the bandwidth is detected to gradually get better, frame dropping is stopped, so that the quality of the pushed streams in the stream push terminal is ensured.

Embodiments of the above-described mechanisms are described merely for the illustrative purpose. The modules that are described as separate parts may or may not be physically separated, and the parts illustrated as modules may or may not be physical modules. That is, these modules may be located in one location, or distributed across multiple network entities. Based on actual needs, some or all of the modules may be selected to achieve the objectives of the present embodiments, which those of ordinary skill in the art may understand and implement without taking creative efforts.

Through the foregoing description of the embodiments, it is clear to those skilled in the art that each embodiment can be implemented by means of software plus a necessary general hardware platform, and certainly, by means of hardware as well. Based on this understanding, the technical solutions, or essentially the parts that contribute to the current technology, can be embodied in the form of a software product. This computer software product may be stored in a computer-readable storage medium, such as a ROM/RAM, a magnetic disc, an optical disc, etc., and include a variety of instructions that cause a computing device (which may be a personal computer, a server, or a network device, etc.) to implement each embodiment or methods described in certain parts of each embodiment.

Although the present disclosure has been described as above with reference to preferred embodiments, these embodiments are not constructed as limiting the present disclosure. Any modifications, equivalent replacements, and improvements made without departing from the spirit and principle of the present disclosure shall fall within the scope of the protection of the present disclosure.

What is claimed is:

1. A network status of stream push terminal-based optimization method, the method comprising:
determining, by the stream push terminal, time for transmission of current data based on a present real-time upstream bandwidth;
evaluating, by the stream push terminal, whether the time for transmission of the current data exceeds a predefined value; and
if the time for transmission of the current data exceeds the predefined value, employing a frame dropping approach to reduce an amount of uploading data.

2. The network status of stream push terminal-based optimization method according to claim 1, wherein determining, by the stream push terminal, the time for transmission of the current data based on the present real-time upstream bandwidth includes:
collecting, by the stream push terminal, audio data and/or video data;
audio-encoding and/or video-encoding, by the stream push terminal, the collected audio data and/or video data, respectively;
encapsulating, by the stream push terminal, the encoded audio data and/or the encoded video data into streaming media format data;
placing, by the stream push terminal, the encapsulated streaming media format data into a to-be-transmitted queue;
retrieving, by the stream push terminal, the streaming media format data from the to-be-transmitted queue, and transmitting, by the stream push terminal, the streaming media format data to a relay terminal;
calculating, by the stream push terminal, the present real-time upstream bandwidth by determining in real-time an amount of streaming media format data transmitted in a unit of time; and
determining, by the stream push terminal, the time for transmission of the current data based on the present real-time upstream bandwidth.

3. The network status of stream push terminal-based optimization method according to claim 2, further comprising:
if the time for transmission of the current data does not exceed the predefined value, continuing transmitting, by the stream push terminal, remaining streaming media format data sequentially from the to-be-transmitted queue.

4. A network status of stream push terminal-based optimization system, the system comprising a stream push terminal, a viewing terminal, and a relay terminal, the stream push terminal pushing collected streaming media format data, through the relay terminal, to the viewing terminal for viewing, wherein the stream push terminal specifically includes:
a determination module that is configured to determine time for transmission of current data based on a present real-time upstream bandwidth;
an evaluation module that is configured to evaluate whether the time for transmission of the current data exceeds a predefined value; and
a frame dropping module that is configured to employ a frame dropping approach to reduce an amount of uploading data if the time for transmission of the current data exceeds the predefined value.

5. The network status of stream push terminal-based optimization system according to claim 4, wherein the determination module specifically includes:
a collection submodule that is configured to collect audio data and/or video data;
an encoding submodule that is configured to audio-encode and/or video-encode the collected audio data and/or video data, respectively;
a streaming protocol submodule that is configured to encapsulate the encoded audio data and/or the encoded video data into streaming media format data; and
a bandwidth inspection submodule that is configured to place the encapsulated streaming media format data into a to-be-transmitted queue, retrieve the streaming media format data from the to-be-transmitted queue and transmit the streaming media format data to the relay terminal, calculate the present real-time upstream bandwidth by determining in real-time an amount of streaming media format data transmitted in a unit of time, and determine the time for transmission of the current data based on the present real-time upstream bandwidth.

6. The network status of stream push terminal-based optimization system according to claim 5, wherein the stream push terminal further specifically includes:
a transmission module that is configured to continue transmitting remaining streaming media format data sequentially from the to-be-transmitted queue if the time for transmission of the current data does not exceed the predefined value.

7. A stream push terminal comprising:
a determination module that is configured to determine time for transmission of current data based on a present real-time upstream bandwidth;
an evaluation module that is configured to evaluate whether the time for transmission of the current data exceeds a predefined value; and
a frame dropping module that is configured to employ a frame dropping approach to reduce an amount of uploading data if the time for transmission of the current data exceeds the predefined value.

8. The stream push terminal according to claim 7, wherein the determination module specifically includes:
a collection submodule that is configured to collect audio data and/or video data;
an encoding submodule that is configured to audio-encode and/or video-encode the collected audio data and/or video data, respectively;
a streaming protocol submodule that is configured to encapsulate the encoded audio data and/or the encoded video data into streaming media format data; and
a bandwidth inspection submodule that is configured to place the encapsulated streaming media format data into a to-be-transmitted queue, retrieve the streaming media format data from the to-be-transmitted queue and transmit the streaming media format data to a relay terminal, and calculate the present real-time upstream bandwidth by determining in real-time an amount of streaming media format data transmitted in a unit of time.

9. The stream push terminal according to claim 8, wherein the bandwidth inspection submodule is further configured to determine the time for transmission of the current data based on the present real-time upstream bandwidth.

10. The stream push terminal according to claim 9, wherein the stream push terminal further specifically includes:
a transmission module that is configured to continue transmitting remaining streaming media format data sequentially from the to-be-transmitted queue if the time for transmission of the current data does not exceed the predefined value.
